(19) United States
(12) Patent Application Publication
(10) Pub. No.: US 2024/0404767 A1
(43) Pub. Date: Dec. 5, 2024

(54) CIRCUIT BREAKER DEVICE

(71) Applicant: Siemens Aktiengesellschaft, München (DE)

(72) Inventor: Marvin Tannhäuser, Hausen (DE)

(21) Appl. No.: 18/696,507

(22) PCT Filed: Sep. 20, 2022
(86) PCT No.: PCT/EP2022/076036

§ 371 Date: Mar. 28, 2024

(30) Foreign Application Priority Data
Sep. 28, 2021 (DE) 10 2021 210 829.6

(51) Int. Cl. H01H 9/54

(52) U.S. Cl. CPC H01H 9/547

(57) ABSTRACT

A circuit breaker device for protecting an electrical low-voltage circuit includes a housing having grid-side connections and at least one load-side connection. A mechanical isolating contact unit is connected to an electronic interruption unit in series, the mechanical isolating contact unit being associated with the load-side connection and the electronic interruption unit being associated with the grid-side connection. The level of the current in the low-voltage circuit, in particular between the grid-side phase conductor connection and the load-side phase conductor connection, is ascertained. If current limits and/or current/time limits are exceeded, a process for preventing a current flow of the low-voltage circuit is initiated. A measurement impedance is provided between two conductors of the low-voltage circuit. Said measurement impedance is connected to the connection between the mechanical isolating contact unit and the electronic interruption unit.

The invention relates to the technical field of a circuit breaker device for a low-voltage circuit having an electronic interruption unit and to a method for a circuit breaker device for a low-voltage circuit having an electronic interruption unit.

The term ‘low voltage’ refers to voltages of up to 1,000 volts AC or up to 1,500 volts DC. Low voltage refers in particular to voltages that are greater than extra-low voltage, with values of 50 volts AC or 120 volts DC.

The terms low-voltage circuit, or grid or system, refer to circuits with nominal currents or rated currents of up to 125 Ampere, more specifically up to 63 Ampere. A low-voltage circuit refers in particular to circuits with nominal currents or rated currents of up to 50 Ampere, 40 Ampere, 32 Ampere, 25 Ampere, 16 Ampere or 10 Ampere. The current values given refer in particular to nominal, rated and/or cut-off currents, i.e. the maximum current that is normally passed through the circuit or at which the electric circuit is typically disconnected, for example by a protective device such as a circuit breaker device, in-line circuit breaker or power circuit breaker. The rated currents can be graduated further, from 0.5 A through 1 A, 2 A, 3 A, 4 A, 5 A, 6 A, 7 A, 8 A, 9 A, 10 A, etc. up to 16 A.

In-line circuit breakers are long-known overcurrent protection devices that are used in electrical installation technology in low-voltage electric circuits. These protect cables from damage caused by heating due to excessive current and/or short circuits. An in-line circuit breaker can switch off the circuit automatically in the event of overload and/or short circuit. An in-line circuit breaker is a non-automatically resetting fuse element.

In contrast to in-line circuit breakers, power circuit breakers are designed for currents greater than 125 A, in some cases even as low as 63 Ampere. For this reason, in-line circuit breakers are simpler and more delicate in structure. Miniature circuit breakers usually have a mounting facility for mounting on a so-called top-hat rail (DIN rail, TH35).

In-line circuit breakers are electromechanical in design. In a housing, they have a mechanical switching contact or working current trip unit to interrupt (trip) the electrical current. Usually, a bimetallic protective element or bimetallic element is used for tripping (interruption) in the event of prolonged overcurrent (overcurrent protection) or thermal overload (overload protection). An electromagnetic trip unit with a coil is used for rapid tripping if an overcurrent limit value is exceeded or in the event of a short circuit (short-circuit protection). One or more arc quenching chamber(s) or devices for arc quenching are provided. in addition to connecting elements for conductors of the electric circuit to be protected.

Circuit breakers with an electronic interruption unit are relatively new developments. These have a semiconductor-based electronic interruption unit. In other words, the electrical current flow of the low-voltage circuit is conducted via semiconductor devices or semiconductor switches, which interrupt the electrical current flow or can be switched to a conductive state. Circuit breakers having an electronic interruption unit also frequently have a mechanical isolating contact system, in particular having isolator switch properties conforming to relevant standards for low-voltage circuits, the contacts of the mechanical isolating contact system being connected in series with the electronic interruption unit, i.e. the current of the low-voltage circuit to be protected is conducted via both the mechanical isolating contact system and the electronic interruption unit.

The invention relates in particular to low-voltage alternating current circuits, having an alternating voltage, usually with a time-dependent sinusoidal alternating voltage at the frequency f. The temporal dependence of the instantaneous voltage value u (t) of the alternating voltage is described by the equation:

$$u ( t ) = U ⋆ sin ( 2 π ⋆ f ⋆ t )$$

where:
u(t)=instantaneous voltage value at time t
U=amplitude of the voltage

A harmonic alternating voltage can be represented by the rotation of a pointer, the length of which corresponds to the amplitude (U) of the voltage. The instantaneous deflection is the projection of the vector onto a coordinate system. One oscillation period corresponds to a full rotation of the pointer and its full angle is 2π(2Pi) or 360°. The angular frequency is the rate of change of the phase angle of this rotating pointer. The angular frequency of a harmonic oscillation is always 2n times its frequency, i.e.:

$$ω = 2 π * f = 2 π / T = angular frequency of the AC voltage$$

(T=period of the oscillation)

Often, the use of angular frequency (ω) is preferred over the frequency (f), since many formulae from oscillation theory can be more compactly represented by means of the angular frequency due to the form of trigonometric functions, the period of which is 2n by definition:

$$u ( t ) = U * sin ( ω t )$$

In the case of angular frequencies that are non-constant over time, the term instantaneous angular frequency is also used.

In the case of a sinusoidal, in particular constant AC voltage over time, the time-dependent value formed by the angular velocity ω and the time t corresponds to the time-dependent angle φ(t), which is also referred to as the phase angle φ(t). This means that the phase angle φ(t) passes through the range 0 . . . 2π or 0° . . . 360° periodically. This means that the phase angle periodically assumes a value between 0 and 2π or 0° and 360° (φ=n*(0 . . . 2π) or φ=n*(0° . . . 360°), due to periodicity; in short: φ=0 . . . 2π or φ=0° . . . 360°).

The instantaneous voltage value u (t) therefore refers to the instantaneous value of the voltage at time t, i.e., for a sinusoidal (periodic) alternating voltage, the value of the voltage at the phase angle φ(φ=0 . . . 2π or φ=0° . . . 360°, of the respective period).

The object of the present invention is to improve a circuit breaker device of the type mentioned above, in particular to improve the safety of such a circuit breaker device or to achieve a higher safety in the electrical low-voltage circuit to be protected by the circuit breaker device.

This object is achieved by a circuit breaker device having the features of patent claim 1.

According to the invention, a circuit breaker for protecting an electric low-voltage circuit, in particular low-voltage AC voltage circuit, is proposed, comprising:
a housing with at least one grid-side connection and one load-side connection,
a mechanical isolating contact unit connected in series with an electronic interruption unit, the mechanical isolating contact unit being assigned to the load-side connection and the electronic interruption unit being assigned to the grid-side connection,
that the mechanical isolating contact unit can be switched by opening at least one contact to prevent a current flow or by closing the at least one contact to allow a current flow in the low-voltage circuit,
that the electronic interruption unit can be switched by means of semiconductor-based switching elements into a high-resistance state of the switching elements in order to prevent a current flow or into a low-resistance state of the switching elements to allow a current flow in the low-voltage circuit,
a current sensor unit for determining the level of the current in the low-voltage circuit,
a control unit, which is connected to the current sensor unit, the mechanical isolating contact unit and the electronic interruption unit, wherein if current limits and/or current-time limits are exceeded, a process of preventing a current flow in the low-voltage circuit is initiated.

According to the invention, a measurement impedance is provided between conductors of the low-voltage circuit in such a way that, when the contacts of the mechanical isolating contact unit are open and the electronic interruption unit is switched to low-resistance, a measurement current flows through the electronic interruption unit via the grid-side connections.

The measurement impedance can be connected, for example, at one end to the connection between the mechanical isolating contact unit and the electronic interruption unit. At the other end, the measurement impedance may be connected, for example, to the other conductor, in particular to the other conductor at the grid-side connection.

A measurement current can flow through the two conductors in front of the load-side connection, in particular in front of the mechanical isolating contact unit assigned to the load-side connection, when the contacts of the mechanical isolating contact unit are open, i.e. when the load/consumer is disconnected from the grid side (power source). The measurement current can be advantageously used for functional testing of the circuit breaker device. This design allows a safe circuit breaker device to be provided, thereby increasing safety in the low-voltage circuit.

Advantageous embodiments of the invention are specified in the dependent claims and the exemplary embodiment.

In an advantageous embodiment of the invention, a measurement impedance is connected in particular between the grid-side connection points of the mechanical isolating contact unit. In particular, the measurement impedance is an electrical resistor or/and capacitor, i.e. a single component or a series or parallel connection or a series and parallel connection of two, three, four, five, . . . components. Specifically, the measurement impedance should have a high resistance value or impedance value to advantageously minimize the losses. In particular, resistance values of greater than 100 kOhm, 500 kOhm, better 1 MOhm, 2 MOhm, 3 MOhm, 4 MOhm or 5 MOhm should be provided, more specifically of greater than 5 MOhm. In a 230 volt low-voltage circuit, the use of a measurement resistor of e.g. 1 MOhm leads to losses of approximately 50 mw.

In an advantageous embodiment, the value of the measurement impedance should be dimensioned such that the current through the measurement impedance with the grid voltage applied (in the nominal range) is less than 1 mA, so that the losses in the measurement impedance ZM are (negligibly) small. The (measurement) current is preferably less than 0.1 mA.

This has the particular advantage that a better check of the functionality of the electronic interruption unit is provided, in particular with open isolating contacts, specifically in the architecture of the circuit breaker device according to the invention.

In an advantageous embodiment of the invention, the circuit breaker device is designed in such a way that the electronic interruption unit (EU) is switched to a low-resistance state for a first period of time for functional testing of the circuit breaker device with open contacts of the mechanical isolating contact unit and the electronic interruption unit switched to a high-resistance state.

This means that the electronic interruption unit is switched to the low-resistance state for a first period of time, starting from the high-resistance state, and is then switched back to the high-resistance state.

The first time period can be in the range 100 μs to 1 s. For example, 100 μs, 200 μs, . . . , 1 ms, 2 ms, . . . , 10 ms, 11 ms, . . . , 20 ms, 21 ms, . . . , 100 ms, . . . , 200 ms, . . . 1 s.

For switching times in the range 1 ms to 2 ms, a voltage change can be detected for the functional test. For time periods from 20 ms to 100 ms or 1 second, it can be checked (multiple times) whether a voltage of approximately 0 V (instantaneous or also rms value of the voltage) is present across the electronic interruption unit.

This has the particular advantage that the electronic interruption unit can be checked with regard to its “switch-on capability”, wherein the measurement impedance produces a detectable measurement current for functional testing.

In an advantageous embodiment of the invention, the circuit breaker device is designed in such a way that the level of the voltage across the electronic interruption unit can be determined (for one conductor).

This has the particular advantage that the level of the voltage between the grid-side connection point and the load-side connection point of the electronic interruption unit can be or is determined.

In an advantageous embodiment of the invention, the level of the voltage across the electronic interruption unit is determined when the electronic interruption unit is switched to the low-resistance state for the first time period. If a second voltage threshold value is exceeded, a second fault condition is present so that a further or subsequent low-resistance state of the electronic interruption unit is prevented or/and the closing of the contacts is prevented. (In other words, there is no fault condition present if the second voltage threshold is undershot.) The second voltage threshold should be 1 volt, or better, less than 1 volt.

This has the particular advantage that the electronic interruption unit can be checked more accurately with regard to its “switch-on capability”, wherein the measurement impedance provides a defined potential.

In an advantageous embodiment of the invention, the circuit breaker device is designed in such a way that, when the contacts of the mechanical isolating contact unit are open, the level of the voltage across the electronic interruption unit is determined with the electronic interruption unit switched to a high-resistance state. If a first voltage threshold value is undershot, a first fault condition is present so that a (possibly repeated or initial) low-resistance state of the electronic interruption unit is prevented or/and closure of the contacts is prevented. (In other words, there is no fault condition present if the first voltage threshold is exceeded.)

This is used to check the electronic interruption unit for its “switch-off capability”, i.e. the semiconductor-based switching elements being switched to a high-resistance state.

The first voltage threshold value is, for example, advantageously 5-15% of the nominal voltage of the low-voltage circuit, for example 10%.

This has the particular advantage that a simple check with regard to the switch-off behavior of the electronic interruption unit is possible, wherein the measurement impedance on the one hand generates a defined potential and on the other hand the level of the resistance or impedance value of the measurement impedance generates a defined voltage level in conjunction with (the measurable) high-resistance impedance of the electronic interruption unit.

In an advantageous embodiment of the invention, a closure of the contacts of the mechanical isolating contact unit is prevented in the presence of one (of the two) fault conditions. In particular, no enable signal is output to the mechanical isolating contact unit. This means that it is not possible to close the contacts of the mechanical isolating contact unit by means of a handle.

Furthermore, a low-resistance state of the electronic interruption unit can be prevented.

Additional fault conditions may also exist.

This has the particular advantage that only an operational circuit breaker device with an operational electronic interruption unit can be switched on. This increases the operational safety of the circuit breaker device and thus also in the low-voltage circuit. This ensures that the switch-on and the switch-off capability of the electronic interruption unit is functioning.

In an advantageous embodiment of the invention, the circuit breaker device may further be designed such that further refinements are provided:
a housing with a grid-side neutral conductor terminal, a grid-side phase conductor terminal, a load-side neutral conductor terminal, a load-side phase conductor terminal of the low-voltage circuit,
an in particular two-pole (especially in the case of a single-phase circuit), mechanical isolating contact unit with load-side connection points and grid-side connection points, wherein the load-side connection points are connected to the load-side neutral and phase conductor terminals, so that opening of contacts to prevent a current flow or closing of contacts to allow a current flow in the low-voltage circuit can be switched,
an in particular single-pole electronic interruption unit, having a grid-side connection point electrically connected to the grid-side phase conductor terminal, and
a load-side connection point connected to a grid-side connection point of the mechanical isolating contact unit,
wherein the electronic interruption unit can be switched by means of semiconductor-based switching elements into a high-resistance state of the switching elements in order to prevent a current flow or into a low-resistance state of the switching elements to allow a current flow in the low-voltage circuit,
a current sensor unit for determining the level of the current in the low-voltage circuit,
a control unit, which is connected to the current sensor unit, the mechanical isolating contact unit and the 8 electronic interruption unit, wherein if current limits and/or current-time limits are exceeded, a process of preventing a current flow in the low-voltage circuit is initiated.

The level of the voltage between the grid-side connection point and the load-side connection point of the electronic interruption unit can be determined or is determined.

At least one voltage sensor unit connected to the control unit may be provided for this purpose. If multiple voltage sensor units are present, they are connected to the control unit.

With the determination of the level of the voltage across the electronic interruption unit, the operability of the electronic interruption unit can be determined according to the invention. According to the invention, an increased operational safety of a circuit breaker device is thus achieved. Furthermore, a novel architecture or constructional design of a circuit breaker device is proposed.

In an advantageous embodiment of the invention, a first voltage sensor unit connected to the control unit is provided, which determines the level of a/the first voltage across the electronic interruption unit, in particular between the grid-side connection point and the load-side connection point of the electronic interruption unit.

This has the particular advantage that a simple solution with only one voltage sensor unit is provided.

In an advantageous embodiment of the invention, a second voltage sensor unit connected to the control unit is alternatively provided, which determines the level of a second voltage between the grid-side neutral conductor terminal and the grid-side phase conductor terminal. Furthermore, a third voltage sensor unit connected to the control unit is provided, which determines the level of a third voltage between a grid-side neutral conductor terminal and a load-side connection point of the electronic interruption unit. The circuit breaker device is designed in such a way that the difference between the second and third voltage determines the level of a/the first voltage between the grid-side connection point and the load-side connection point of the electronic interruption unit.

This has the particular advantage that another solution based on classical voltage measurements is provided. More extensive testing of the circuit breaker device is also made possible.

In an advantageous embodiment of the invention, the current sensor unit is provided on the circuit side between the grid-side phase conductor terminal and the load-side phase conductor terminal.

This has the particular advantage of providing a compact bifurcation of the device, with an electronic interruption unit in the phase conductor alongside a current sensor unit on the one hand, and a continuous neutral conductor on the other. Furthermore, a current sensor unit in the phase conductor ensures more extensive monitoring with regard to currents both in the circuit itself and in the case of ground fault currents.

In an advantageous embodiment of the invention the low-voltage electrical circuit is a three-phase AC circuit. The circuit breaker device has a plurality of or further grid-side and load-side phase conductor terminals to protect the phases of the electrical circuit. Between each of the grid-side and load-side phase conductor terminals, a series circuit of an electronic interruption unit or its semiconductor-based switching elements and a contact of the mechanical isolating contact unit is provided. A measurement impedance can be provided between the respective phase conductor and neutral conductor. A measurement impedance can also be provided between two different phase conductors.

This has the particular advantage that it enables protection for the three-phase AC circuit.

In an advantageous embodiment of the invention, the circuit breaker device is designed in such a way that the contacts of the mechanical isolating contact unit can be opened by the control unit, but not closed.

This has the particular advantage that increased operational safety is achieved, as the contacts cannot be accidentally closed by the control unit.

In an advantageous embodiment of the invention, the mechanical isolating contact unit can be operated by a mechanical handle in order to switch between opening of the contacts or closing of the contacts.

This has the particular advantage that it provides the functionality of a classical in-line circuit breaker.

In an advantageous embodiment of the invention, the mechanical isolating contact unit is designed in such a way that closing of the contacts by the mechanical handle is only possible after an enable, in particular an enable signal.

This has the particular advantage that increased protection and increased operational safety are provided, since switching on a defective circuit breaker is prevented.

In an advantageous embodiment of the invention, a power supply is provided, in particular for the control unit, which is connected to the grid-side neutral conductor terminal and the grid-side phase conductor terminal. Specifically, a protection device, in particular a fuse, or/and a switch is provided in the connection to the grid-side neutral conductor terminal. Specifically, the measurement impedance can be advantageously connected to the grid-side neutral conductor terminal via this connection (fuse and/or switch).

This has the particular advantage that a compact electronic assembly is enabled. In addition, there is only one cross connection between the phase conductor and neutral conductor in the circuit breaker device. A fault in the circuit breaker device that causes a short circuit between the phase conductor and the neutral conductor can thus be easily protected, secured or found. The power supply can be advantageously disconnected from the grid using the switch, for example, in order to enable insulation measurements.

In an advantageous embodiment of the invention, with the contacts of the mechanical isolating contact unit closed and low resistance of the interruption unit, and
with a determined current that exceeds a first current value, in particular that the first current value is exceeded for a first time limit, the electronic interruption unit becomes high resistance and the mechanical isolating contact unit remains closed,
with a determined current that exceeds a (higher) second current value, in particular for a second time limit, the electronic interruption unit becomes high resistance and the mechanical isolating contact unit is opened,
with a determined current that exceeds an (even higher) third current value, the electronic interruption unit becomes high resistance and the mechanical isolating contact unit is opened.

This has the particular advantage of providing a staged shut-down design in the event of elevated currents for a circuit breaker device according to the invention.

In an advantageous embodiment of the invention, the control unit comprises a microcontroller.

This has the particular advantage that the functions according to the invention for increasing the safety of a circuit breaker, or the electric low-voltage circuit to be protected, can be implemented by an (adaptable) computer program product. Furthermore, changes and improvements to the function can thus be individually loaded onto a circuit breaker device.

According to the invention, a corresponding method for a circuit breaker device for a low-voltage circuit with electronic (semiconductor-based) switching elements having the same and further advantages can be provided.

The method for a circuit breaker device for protecting a low-voltage electrical circuit with:
a housing with at least one grid-side connection and one load-side connection,
a mechanical isolating contact unit connected in series with an electronic interruption unit, the mechanical isolating contact unit being assigned to the load-side connection and the electronic interruption unit being assigned to the grid-side connection,
that the mechanical isolating contact unit can be switched by opening contacts to prevent a current flow or by closing the contacts to allow a current flow in the low-voltage circuit,
that the electronic interruption unit can be switched by means of semiconductor-based switching elements into a high-resistance state of the switching elements in order to prevent a current flow or into a low-resistance state of the switching elements to allow a current flow in the low-voltage circuit,
that the level of the current in the low-voltage circuit, in particular between the grid-side phase conductor terminal and load-side phase conductor terminal, is determined and, if current limits and/or current-time limits are exceeded, a process of preventing a current flow in the low-voltage circuit is initiated,
that a measurement impedance is provided between two conductors of the low-voltage circuit, wherein the measurement impedance is connected at one end to the connection between the mechanical isolating contact unit and the electronic interruption unit.

For functional testing of the circuit breaker device, the electronic interruption unit is switched to a low-resistance state for a first period of time with open contacts of the mechanical isolating contact unit and with the electronic interruption unit switched to a high-resistance state.

The level of the voltage across the electronic interruption unit is determined when the electronic interruption unit is switched to the low-resistance state for the first time period. If a second voltage threshold value is exceeded, a second fault condition is present, so that a further low-resistance state of the electronic interruption unit is prevented or/and the closing of the contacts is prevented.

When the contacts of the mechanical isolating contact unit are open and the electronic interruption unit (EU) is switched to a high-resistance state, the level of the voltage across the electronic interruption unit can also be determined. If a/the first voltage threshold value is undershot, a first fault condition is present, so that a low-resistance state of the electronic interruption unit is prevented or/and closure of the contacts is prevented.

According to the invention, a corresponding computer program product can be claimed. The computer program product comprises commands which, when the program is executed by a microcontroller, cause said microcontroller to improve the safety of such a circuit breaker device, or to achieve a higher level of safety in the electrical low-voltage circuit to be protected by the circuit breaker device.

The microcontroller is part of the circuit breaker device, in particular the control unit.

According to the invention a corresponding computer-readable storage medium, on which the computer program product is stored, can be claimed.

According to the invention, a corresponding data carrier signal which transmits the computer program product can be claimed.

All embodiments, whether in dependent form referred back to patent claim 1 or referred back only to individual features or combinations of features of patent claims, bring about an improvement of a circuit breaker device, in particular an improvement in the safety of a circuit breaker device or consequently of the electrical circuit, and provide a new design for a circuit breaker device.

The described properties, features and advantages of the present invention and the manner in which they are achieved will become clearer and more comprehensible in conjunction with the following description of the exemplary embodiments, which are explained in more detail in connection with the drawings.

### In the Drawing:

FIG. 1 shows a first illustration of a circuit breaker device,

FIG. 2 shows a second illustration of a circuit breaker device,

FIG. 3 shows a third illustration of a circuit breaker device with first voltage waveforms,

FIG. 4 shows a fourth illustration of a circuit breaker device with second voltage waveforms,

FIG. 5 shows a fifth illustration of a circuit breaker device.

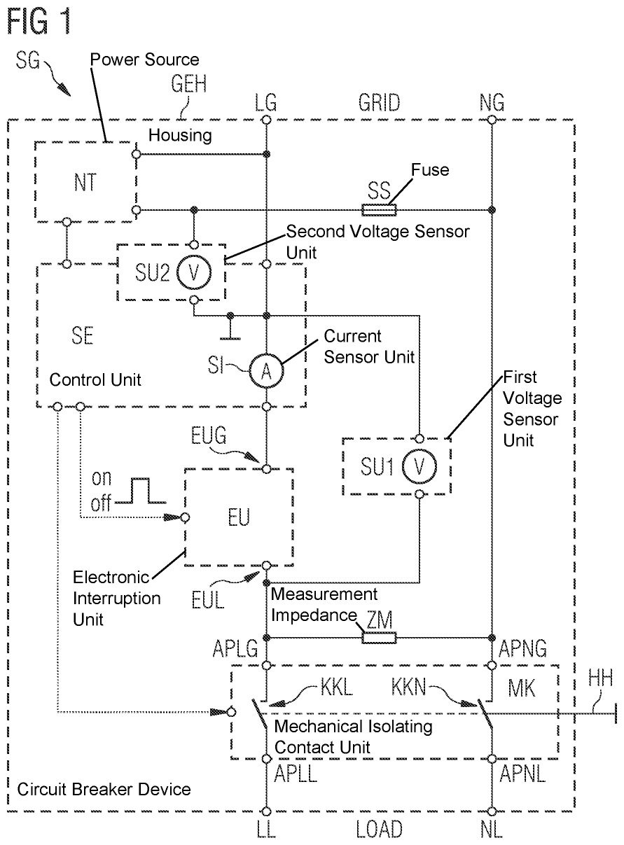

FIG. 1 shows an illustration of a circuit breaker device SG for the protection of a low-voltage electrical circuit, in particular a low-voltage AC circuit, having a housing GEH, comprising:
grid-side neutral conductor terminal NG, a grid-side phase conductor terminal LG, a load-side neutral conductor terminal NL, a load-side phase conductor terminal LL of the low-voltage circuit;
a power source is usually connected to the grid side GRID;
a load is usually connected to the load side LOAD;
a (two-pole) mechanical isolating contact unit MK with load-side connection points APLL, APNL and grid-side connection points APLG, APNG,
wherein a load-side connection point APNL is provided for the neutral conductor, a load-side connection point APLL for the phase conductor, a grid-side connection point APNG for the neutral conductor, and a grid-side connection point APLG is provided for the phase conductor. The load-side connection points APNL, APLL are connected to the load-side neutral and phase conductor terminals NL, LL, so that it is possible to switch between opening of contacts KKN, KKL to prevent a current flow or closing of the contacts for a current flow in the low-voltage circuit,
an in particular single-pole, electronic interruption unit EU (which is arranged in particular in the phase conductor in the case of a single-pole design,)
with a grid-side connection point EUG, which is electrically connected to the grid-side phase conductor terminal LG, and
a load-side connection point EUL, which has an electrical connection or is connected to the grid-side connection point APLG of the mechanical isolating contact unit MK, wherein the electronic interruption unit can be switched by means of semiconductor-based switching elements into a high-resistance state of the switching elements in order to prevent a current flow or into a low-resistance state of the switching elements to allow a current flow in the low-voltage circuit,
a current sensor unit SI, for determining the level of the current in the low-voltage circuit, which is arranged in particular in the phase conductor,
a control unit SE, which is connected to the current sensor unit SI, the mechanical isolating contact unit MK and the electronic interruption unit EU, wherein if current limits and/or current-time limits are exceeded, a process of preventing a current flow in the low-voltage circuit is initiated.

According to the invention, a measurement impedance is provided between conductors of the low-voltage circuit in such a way that, when the contacts of the mechanical isolating contact unit are open and the electronic interruption unit is switched to low-resistance, a measurement current flows through the electronic interruption unit via the grid-side connections.

This can be carried out in such a way that a measurement impedance ZM is connected between the grid-side connection points APLG, APNG of the mechanical isolating contact unit MK. The measurement impedance ZM can be, for example, an electric resistor or/and a capacitor. In particular, the measurement impedance may be a series circuit or (/and) parallel circuit of a resistor or/and capacitor.

The measurement impedance generates a defined potential in the circuit breaker device, in particular a defined voltage potential across the electronic interruption unit EU. It also generates a defined measurement current in the circuit breaker device without affecting a connected consumer/load.

Both the measurement current can be evaluated according to the invention, as well as (or/and) the voltage across specific units, such as the electronic interruption unit EU.

The correct behavior of the units, in particular the electronic interruption unit EU, can be detected by the evaluation.

The measurement impedance ZM should have a high value (resistance or impedance value) to advantageously minimize the losses. For example, for a resistor a value of, for example, 1 MOhm. A value of 1 MOhm results in losses of approximately 50 mW in a 230 V low-voltage circuit.

The measurement impedance should be greater than 100 kOhm, 500 kOhm, 1 MOhm, 2 MOhm, 3 MOhm, 4 MOhm or better, 5 MOhm.

The circuit breaker device can be designed in such a way that the level of the voltage across the electronic interruption unit can be determined. This means that the level of a first voltage between the grid-side connection point EUG and the load-side connection point EUL of the electronic interruption unit EU can be determined or is determined.

For this purpose, in the example according to FIG. 1 a first voltage sensor unit SU1 connected to the control unit SE is provided, which determines the level of the voltage between grid-side connection point EUG and load-side connection point EUL of the electronic interruption unit EU.

In the voltage measurement using the first voltage sensor unit SU1, the voltage across the series circuit of electronic interruption unit EU and current sensor SI can alternatively also be determined, as shown in FIG. 1. The current sensor unit SI has a very low internal resistance, so that the determination of the level of the voltage is not affected, or only negligibly.

Advantageously, a second voltage sensor unit SU2 can be provided, which determines the level of the voltage between the grid-side neutral conductor terminal NG and the grid-side phase conductor terminal LG.

The first voltage sensor unit can also be replaced by using two voltage measurements (before the electronic interruption unit and after the electronic interruption unit). A difference formation is used to determine the voltage across the electronic interruption unit.

Thus, a/the second voltage sensor unit SU2 connected to the control unit SE can be provided, which determines the level of a second voltage between the grid-side neutral conductor terminal (NG) and grid-side phase conductor terminal (LG). Furthermore, a third voltage sensor unit SU3 connected to the control unit (not shown) can be provided, which determines the level of a third voltage between the grid-side neutral conductor terminal NG and load-side connection point EUL of the electronic interruption unit EU. The circuit breaker device is designed in such a way that the difference between the second and third voltage determines the level of a/the first voltage between the grid-side connection point EUG and the load-side connection point EUL of the electronic interruption unit EU.

In the example according to FIG. 1, the electronic interruption unit EU has a single-pole design, in the example in the phase conductor. Here, the grid-side connection point APNG for the neutral conductor of the mechanical isolating contact unit MK is connected to the grid-side neutral conductor terminal NG of the housing GEH.

The circuit breaker device SG is advantageously designed such that the contacts of the mechanical isolating contact unit MK can be opened by the control unit SE, but not closed, which is indicated by an arrow from the control unit SE to the mechanical isolating contact unit MK.

The mechanical isolating contact unit MK can be operated by means of a mechanical HH handle on the circuit breaker device SG in order to switch between a manual opening or closing of the contacts KKL, KKN. The mechanical handle HH indicates the switching state (open or closed) of the contacts of the mechanical isolating contact unit MK.

Furthermore, the contact position (or the position of the handle, closed or open) can be transmitted to the control unit SE. The contact position (or the position of the handle) can be determined, for example, by means of a sensor.

The mechanical isolating contact unit MK can be advantageously designed in such a way that (manual) closing of the contacts by means of the mechanical handle is only possible following an enable, in particular an enable signal. This is also indicated by the arrow from the control unit SE to the mechanical isolating contact unit MK. This means that the contacts KKL, KKN of the mechanical isolating contact unit MK can only be closed by the handle HH once the enable or the enable signal (from the control unit) is present. Without the enable or enable signal, the handle HH can be actuated, but the contacts cannot be closed (“continuous slipping”).

The circuit breaker device SG has a power source NT, for example a mains power supply. In particular, the power source NT is provided for the control unit SE, which is indicated in FIG. 1 by a connection between the power source NT and the control unit SE. The power source NT is (on the other hand) connected to the grid-side neutral conductor terminal NG and the grid-side phase conductor terminal LG. A protection device SS, in particular a fuse, can be advantageously provided in the connection to the grid-side neutral conductor terminal NG (or/and phase conductor terminal LG).

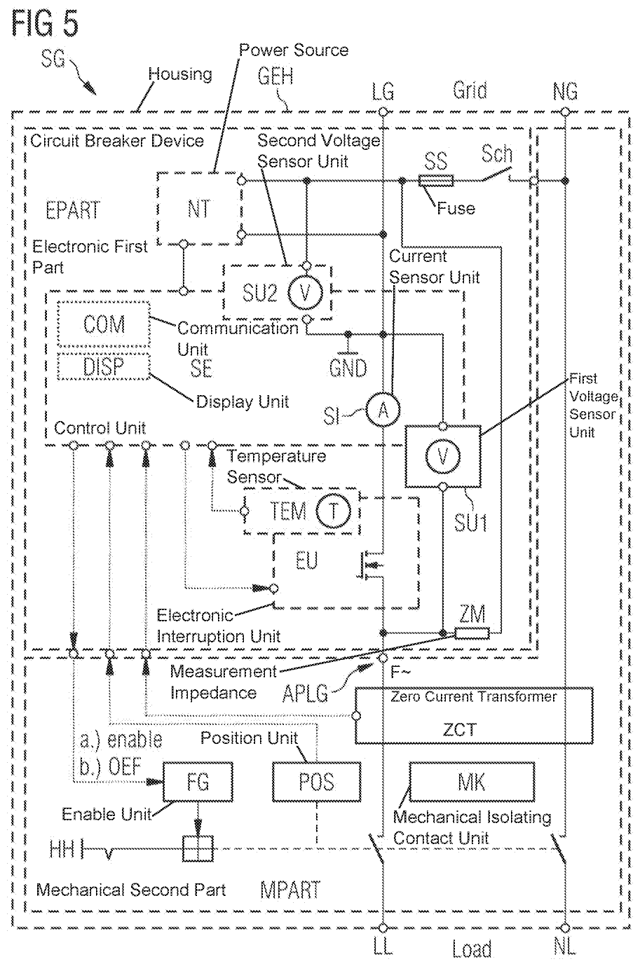

Alternatively, the measurement impedance ZM can be connected to the grid-side neutral conductor terminal NG via the fuse SS. Thus, a three-pole electronic unit EE (FIG. 5) can be advantageously implemented, for example as a module having three connection points, a neutral conductor connection point and two phase conductor connection points. The electronic unit EE comprises, for example, the electronic interruption unit EU, the control unit SE, the power source NT (in particular including fuse SS), the current sensor unit SI, the first voltage sensor unit SU1 and optionally the second voltage sensor unit SU2.

The low-voltage circuit can be a three-phase AC circuit, with one neutral conductor and three phase conductors. For this purpose, the circuit breaker device can be designed as a three-phase variant and, for example, have further grid-side and load-side phase conductor terminals. Similarly, between the further grid-side and load-side phase conductor terminals, a series circuit consisting of an electronic interruption unit, or the semiconductor-based switching elements thereof, and one contact of the mechanical isolating contact unit is provided. The measurement impedances can be provided in each case between the phase conductor and neutral conductor or/and between the phase conductors.

High resistance refers to a state in which only a current of negligible size can flow. In particular, high resistance means resistance values of greater than 1 kilohm, preferably greater than 10 kilohms, 100 kilohms, 1 megohm, 10 megohms, 100 megohms, 1 gigohm or greater.

Low resistance refers to a state in which the current value specified on the circuit breaker could flow. In particular, low resistance means resistance values that are less than ohms, preferably less than 1 ohm, 100 milliohms, 10 milliohms, 1 milliohm or less.

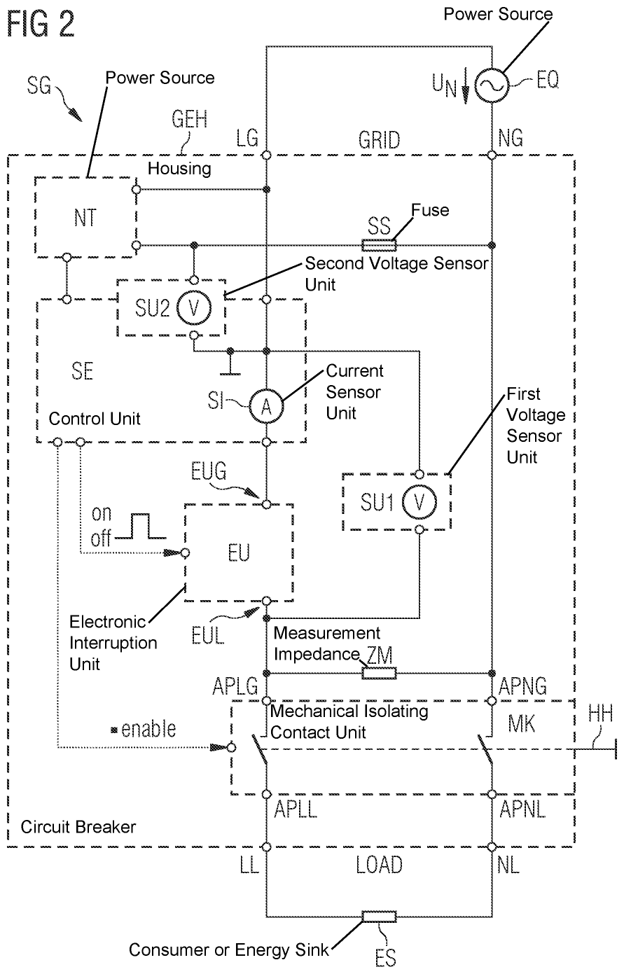

FIG. 2 shows an illustration according to FIG. 1, with the difference that a power source EQ with a nominal voltage U_{N} of the low-voltage circuit is connected to the grid side GRID. Furthermore, a consumer or energy sink ES is connected to the load side LOAD.

Furthermore, an enable signal ‘enable’ is indicated for the connection of the control unit SE to the mechanical isolating contact unit MK.

The mechanical isolating contact unit MK is shown in an open state OFF, i.e. with open contacts KKN, KKL to prevent a current flow.

For example, the circuit breaker device SG works according to the principle that, when the contacts of the mechanical isolating contact unit are closed and the interruption unit is switched to low resistance, and
with a determined current that exceeds a first current value, in particular that the first current value is exceeded for a first time limit, the electronic interruption unit EU becomes high resistance and the mechanical isolating contact unit MK remains closed,
with a determined current that exceeds a higher second current value, in particular for a second time limit, the electronic interruption unit EU becomes high resistance and the mechanical isolating contact unit MK is opened,
with a determined current that exceeds an even higher third current value, the electronic interruption unit becomes high resistance and the mechanical isolating contact unit MK is opened.

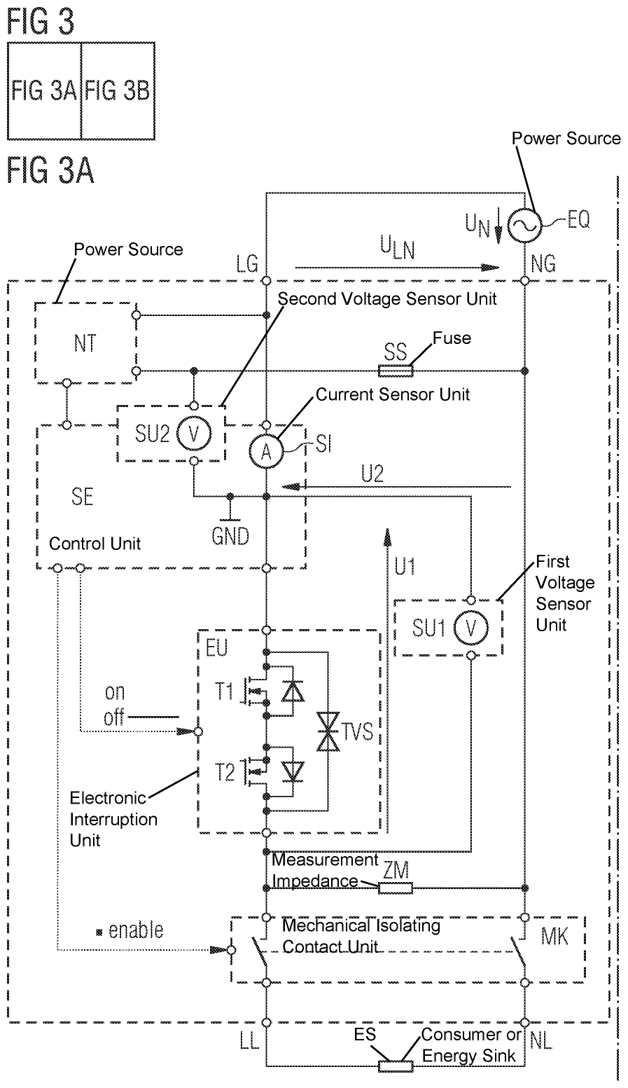

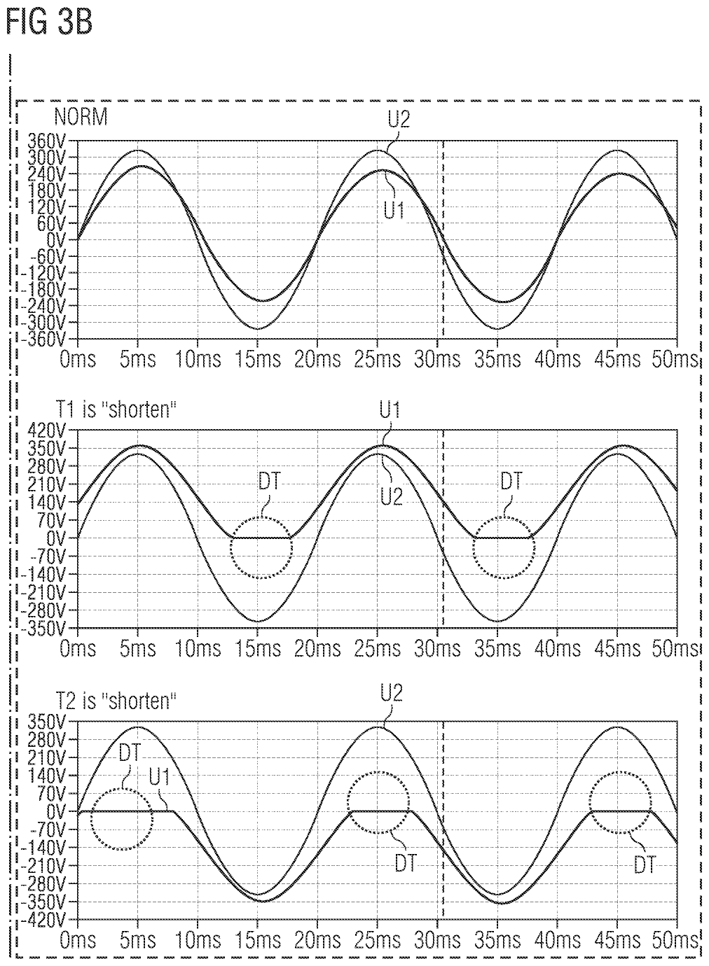

FIG. 3 shows an illustration according to FIG. 2 with various differences. The voltages on and in the circuit breaker device are shown in more detail:
the nominal voltage U_{N} of the power source EQ of the low-voltage circuit,
the grid voltage U_{LN} applied between the grid-side neutral conductor terminal NG and grid-side phase conductor terminal LG,
the second voltage U2 or U_{N,GND} measured in the circuit breaker device by the second voltage sensor unit SU2,
the first voltage U1 or U_{sw} measured across the electronic interruption unit EU with the first voltage sensor unit SU1.

In this variant according to FIG. 3, the first voltage U1 (or U_{sw}) measured directly across the electronic interruption unit (i.e. without current sensor unit SI). The second voltage U2 (or U_{N,GND}) corresponds to the grid voltage U_{IN} minus the (minimum) voltage drop across the current sensor unit SI and the ohmic losses.

Furthermore, a detail of the electronic interruption unit EU is shown, wherein the (single-pole) electronic interruption unit EU comprises semiconductor-based switching elements T1, T2. In the example according to FIG. 3, two semiconductor-based switching elements T1, T2 connected in series are provided. An overvoltage protection device TVS is advantageously provided across the series circuit of the two semiconductor-based switching elements T1, T2.

In the embodiment according to FIG. 3, two unidirectional electronic switching elements are connected (antiserially) in series. The first unidirectional switching element is arranged such that it can be switched in a first current direction and the second unidirectional switching element such that it can be switched in the opposite direction to the current, wherein the unidirectional switching elements are conducting in a direction opposite to their current switching direction (directly or indirectly, e.g. by internal or externally parallel connected diodes). In particular, the circuit breaker device is designed in such a way that the first and the second switching element can be switched independently of each other.

The following situation is considered below:
The rated voltage or grid voltage (e.g. 230 V AC) is applied to the grid-side connection LG, NG or grid side GRID or grid terminal of the circuit breaker device,
A consumer or energy sink ES or load connected to the load side LOAD of the circuit breaker device,

In the first step, the check in the OFF state of the electronic circuit breaker device will be considered.

For this purpose:
The mechanical isolating contact unit is open (contacts open)
The electronic interruption unit is switched off (semiconductor-based switching elements set to high resistance)
The control unit (incl. controller unit) is active

The electrical potential between the electronic interruption unit and the mechanical isolating contact unit is defined by the measurement impedance ZM and the impedance of the electronic interruption unit when switched off (voltage divider).

The control unit can then, at any time (and thus at a certain voltage distribution (depending on the instantaneous value of the voltage, half-wave of the voltage), switch on the semiconductor-based switching elements (which of the two semiconductors is active?). Taking into account the polarity of the alternating voltage or AC voltage, the switching elements of the electronic interruption unit EU can thus be tested.

The electronic interruption unit EU (or the electronic switch) is thus switched on for e.g. a very short time (in the millisecond range). If the electronic interruption unit is operational, this can be established by the (simultaneous) voltage measurement (e.g. first voltage sensor unit, second voltage sensor unit) and (subsequent) evaluation. For example, in the case of a defective semiconductor-based switching element, it can be established whether it remains always switched on (fault pattern: “shorted”) or remains always switched off (fault pattern: “blown”).

Thus, two typical and frequent fault patterns are covered. If the check shows no faults, a (first) enable condition may be present for switching on the circuit breaker device, specifically the electronic interruption unit or the mechanical isolating contact unit.

If the check shows a fault, no enable is issued to switch on the circuit breaker device; a fault condition is present so that the output or consumer/load cannot be switched on and thus a dangerous condition is prevented.

The circuit breaker device is designed in such a way that the level of the voltage across the electronic interruption unit, i.e., the first voltage U1, is determined with the contacts of the mechanical isolating contact unit MK open and the electronic interruption unit EU switched to a high-resistance state. If a first voltage threshold value is undershot, a first fault condition is present, so that a low-resistance state of the electronic interruption unit is prevented or/and closure of the contacts is prevented. With respect to the mechanical isolating contact unit MK, for example, a enable signal ‘enable’ is not issued from the control unit SE to the mechanical isolating contact unit MK.

On the right-hand side of FIG. 3, three corresponding voltage waveforms are shown over time. On the vertical y-axis the voltage is plotted in volts and the time in milliseconds (ms) is plotted on the horizontal x-axis. The course of the magnitude of the first voltage U1 and the magnitude of the second voltage U2 over time is shown in each case.

The first upper curve NORM shows the voltage waveforms for a fault-free state of the electronic interruption unit EU. The difference in amplitude between first voltage U1 and second voltage U2 in this case is caused by the voltage drop across the measurement impedance ZM. The first voltage threshold should be based on the size of the measurement impedance. For example, the first voltage threshold should be slightly lower than the nominal voltage minus the voltage drop across the measurement impedance. If the first voltage U1 is greater than the first voltage threshold, the electronic interruption unit EU is fault-free. The evaluation can be based on both the instantaneous values of the voltage and on the RMS values of the voltage. If the first voltage U1 is greater than the first voltage threshold, a first enable condition is thus present, as a consequence of which the electronic interruption unit is allowed to become low resistance or/and closure of the contacts of the mechanical isolating contact unit is enabled. This is shown in FIG. 3 by an arrow, with the reference sign enable, from the control unit SE to the mechanical isolating contact unit MK, for enabling the closure of the contacts of the mechanical isolating contact unit MK by the handle HH. The connection or the arrow from the control unit SE to the electronic interruption unit EU shows a representation of a course of the switching state of the electronic interruption unit over time, in which a switched-off/high-resistance state is indicated by off and a switched-on/low-resistance state of the electronic interruption unit EU is indicated by on. In the example, the electronic interruption unit EU is in the switched-off state, which is represented by a straight dash next to ‘off’.

In the second, middle graphic ‘T1 is “shorten”’, the voltage curve for a defective electronic interruption unit EU is shown, in which in the example a semiconductor-based switching element, in the example the switching element T1, is permanently conductive (shorten/short-circuited). As a result, in a half-wave of the electrical voltage a current flows through the electronic interruption unit, even though this is (should be) actually high resistance. The conductivity in the current direction affected by the semiconductor-based switching element in question prevents the build-up of a voltage across the semiconductor-based switching element in question. This means that the level of the first voltage U1 cannot exceed the first voltage threshold, which can be determined by means of the first voltage sensor unit SU1 in conjunction with the control unit SE. This is indicated in FIG. 3 by the abbreviation DT.

In the third, middle graphic ‘T2 is “shorten”’, the voltage curve for a defective electronic interruption unit EU is shown, in which the other semiconductor-based switching element, in the example the switching element T2, is permanently conductive (shorten/short-circuited). The same comments as were made about the middle graphic apply.

In the second and third graphics, a fault state of the electronic interruption unit EU is shown, which can be found according to the invention with closed contacts of the mechanical isolating contact unit and a low-resistance state of the interruption unit before the contacts of the mechanical isolating contact unit are closed and which prevents manual closing of the contacts of the mechanical isolating contact unit.

This will be explained again in other words. FIG. 3 shows an overview of the circuit diagram and voltage waveforms for the case in which a switching element in the electronic interruption unit is defective, in this case shorten/short-circuited. Since unidirectionally blocking power semiconductors are typically used, the semiconductor-based switching element T1 or T2 can be tested for operability, depending on the voltage polarity applied. If an alternating voltage is present at the terminals of a functional circuit breaker device, a voltage U1 or U_{sw} is generated across the electronic interruption unit, which can be measured via an appropriate first voltage sensor unit SU1. This is illustrated in the upper graphic NORM. If one of the two switching elements is short-circuited, the voltage can no longer be absorbed by the electronic interruption unit. The measured voltage here becomes zero for a certain period of time (approx. 5 ms). This is shown in the two curves ‘T1 is “shorten” 1’ and ‘T2 is “shorten”’. This allows a defective switching element to be measured or detected. If both switching elements are shorted, the first voltage U1 or U_{sw} is always zero (not shown).

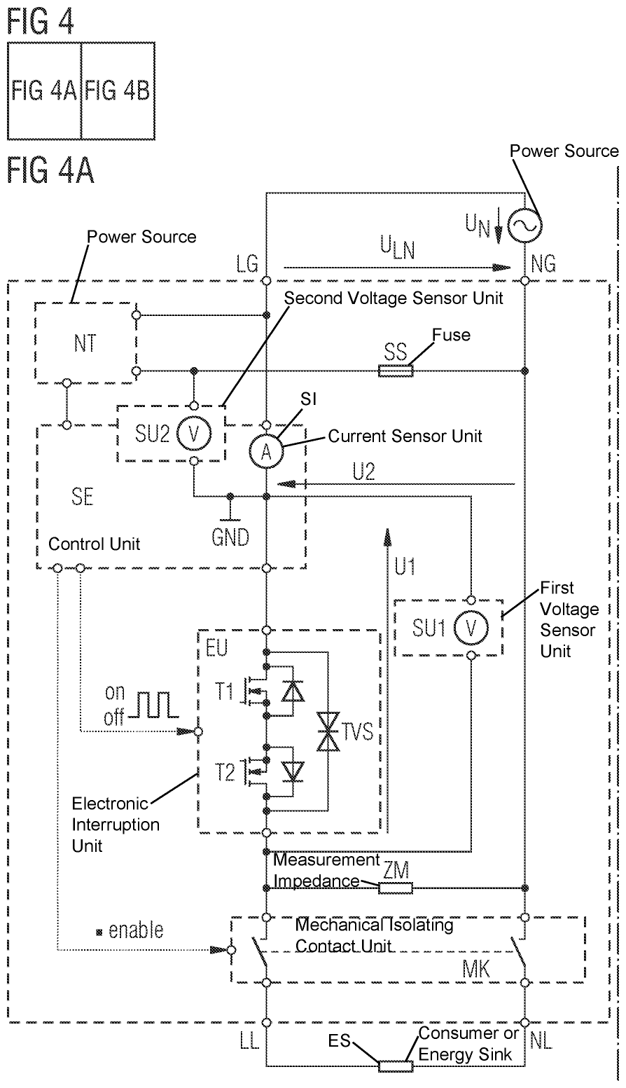

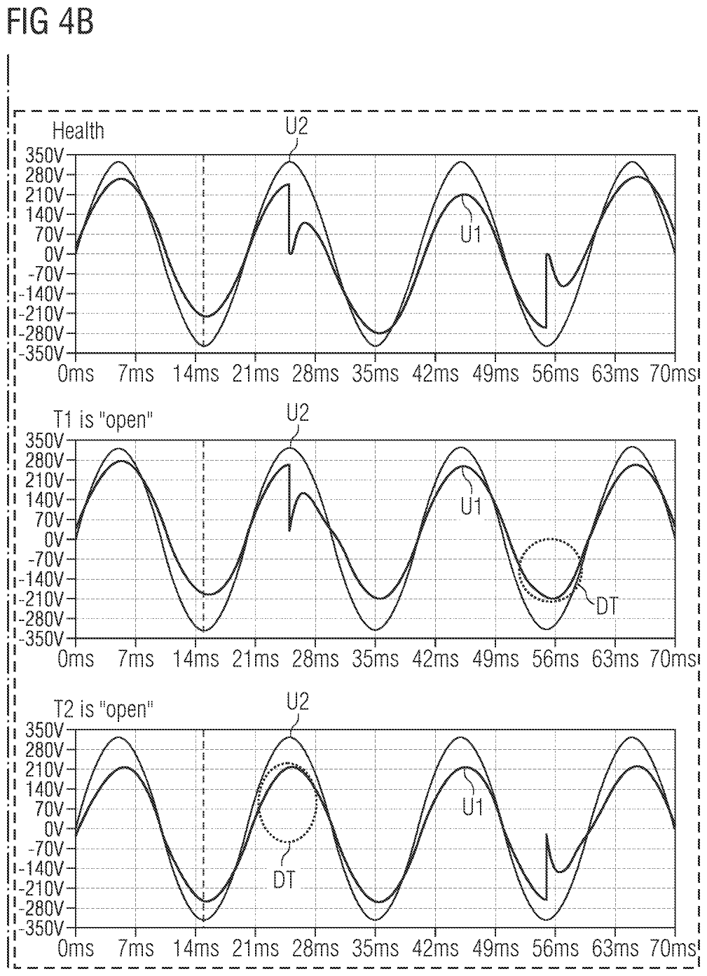

FIG. 4 shows an illustration according to FIG. 3 with the difference that the electronic interruption unit EU is briefly switched on and off. This is indicated by a square wave signal with respect to the states off and on at the connection between the control unit SE and electronic interruption unit EU.

On the right-hand side of FIG. 4, three corresponding graphics according to FIG. 3 are again shown. The graph shows voltage waveforms for the case in which a switching element in the electronic interruption unit is defective, in this case blown/open. Since unidirectionally blocking power semiconductors are typically used, switching element T1 or T2 can be tested for operability, depending on the voltage polarity applied.

If an alternating voltage is present at the functional circuit breaker device, a voltage U1 or U_{sw} is generated across the electronic interruption unit, which can be measured via an appropriate voltage measurement (first voltage sensor unit SU1). This is illustrated in the upper curves “Health”.

In order to check whether one of the two semiconductor-based switching elements has blown, a short switch-on pulse is applied, first time span. If one of the two switching elements included is blown, the switching element can no longer be switched on by the electronic interruption unit. The measured voltage will then remain the same as in the switched-off state, even when it is switched on. This is shown in the middle graphic ‘T1 is “open”’ and the lower graphic ‘T2 is “open”’. This allows a defective switching element to be measured or detected.

In other words, the circuit breaker device is designed in such a way that with the contacts of the mechanical isolating contact unit MK open and the electronic interruption unit EU switched to a high-resistance state, the electronic interruption unit EU is switched to a low-resistance state for a first period of time, and the voltage across the electronic interruption unit EU is measured.

If a second voltage threshold value is exceeded, a second fault condition is present, so that a low-resistance state of the electronic interruption unit is prevented or/and the closing of the contacts is prevented.

The circuit breaker device is advantageously designed such that in the presence of a fault condition, a closing of the contacts of the mechanical isolating contact unit MK is prevented. In particular, no enable signal is output to the mechanical isolating contact unit MK.

FIG. 5 shows an illustration according to FIGS. 1 to 4, with the difference that the circuit breaker device is constructed in two parts. It contains an electronic first part EPART, for example on a printed circuit board. The first part EPART can comprise the control unit SE, the measurement impedance ZM, the current sensor unit SI, the electronic interruption unit EU, and the power source NT. In addition, the first part can comprise the first voltage sensor unit SU1, the second voltage sensor unit SU2, the fuse SS, a switch SCH, a temperature sensor TEM (in particular for the electronic interruption unit EU), a communication unit COM, and a display unit DISP.

The first part EPART has only three connectors:
the grid-side phase conductor terminal LG,
a connector for or to the grid-side phase conductor connection point APLG of the mechanical isolating contact unit MK,
a terminal for a connection to the grid-side neutral conductor terminal NG.

The circuit breaker device contains a second, in particular mechanical, part MPART. The second part MPART can comprise the mechanical isolating contact unit MK, the handle HH, and an enable unit FG. Further, the second part can comprise a position unit POS for reporting the position of the contacts of the mechanical isolating contact unit MK to the control unit, as well as the (neutral conductor) connection(s). Additional, not further designated, units may be provided.

Due to the bifurcation, a compact circuit breaker device according to the invention can be advantageously realized.

The enable unit FG enables the actuation of the contacts of the mechanical isolating contact unit by the handle HH when an enable signal is present.

In the following, the invention will be summarized once again and described in further detail.

As an example, an electronic circuit breaker device is proposed, having:
a housing with grid-side and load-side connections
voltage sensor unit
current sensor unit for measuring the (load) current
mechanical isolating contact unit incl. handle (incl. indication of the contact position, trip by the electronics, isolator switch properties)
electronic interruption unit with semiconductor-based switching elements
control unit
measurement impedance
the operability of the electronic interruption unit is verified,
by continuously measuring the voltage across the electronic interruption unit. In this case, it can be determined, for example, whether a semiconductor device has blown when switched on
by switching the electronic interruption unit on and immediately off again for a short time (<10 ms, preferably <1 ms, in general: <20 ms, 50 ms, 100 ms, 200 ms, 500 ms or 1 s) with the contacts open,
while simultaneously recording voltage readings and/or current readings and analyzing them in such a way that a shorted or blown electronic interruption unit is detected, or shorted or blown switching elements are detected.

It is advantageous to first perform the measurement, then the switching and measuring.

The measurement impedance ensures a defined/definable measurement current or a defined potential/defined/definable voltage drops. The measurement impedance is installed between the two conductors/current paths (phase conductor L and neutral conductor N) in order to define the electrical potential between the electronic interruption unit EU and the mechanical isolating contact unit for measurement purposes (no “floating” potential.)

A computer program product or algorithm is proposed that switches the electronic interruption unit or the semiconductor-based switching elements on and off at appropriate times (instantaneous values of the grid voltage) and at the same time evaluates the measured current and voltage values in order to detect that the electronic interrupt unit is operational or not operational.

The control unit SE can comprise a microcontroller (for this purpose). The computer program product can be executed on the microcontroller. The computer program product comprises commands which, when the program is executed by the microcontroller, cause the latter to control the circuit breaker device, in particular to support the method according to the invention, in particular to carry it out.

The computer program product may be stored on a computer-readable storage medium, such as a CD-ROM, a USB stick or similar.

Also, a data carrier signal that transmits the computer program product may exist.

The time of switching the semiconductor-based switching elements (for the check) depends on the polarity of the currently applied grid voltage, so that individual switching elements can be checked selectively. Furthermore, the instantaneous value of the voltage can be taken into account when selecting the time.

In particular the values are as follows:
the first time period: very short to short, 10 μs to 1 s,
the first voltage threshold value: 5-10% of the (RMS) grid voltage, e.g. 10-20 V, possibly depending on the size of the measurement impedance
the second voltage threshold value: less than 1 volt, relatively independent of the size of the measurement impedance (for high values of the measurement impedance)

### In Summary:

high-resistance measurement impedance (preferably R and/or C) for determining the electrical potential between the electronic interruption unit and the mechanical isolation contact unit
current measurement through or voltage measurement across the electronic interruption unit in order to: detect a shorted or blown state of a power semiconductor
enable the possibility of switching on the mechanical isolating contact unit after fault-free testing of the electronic interruption unit

Although the invention has been illustrated and described in greater detail by means of the exemplary embodiment, the invention is not restricted by the examples disclosed and other variations can be derived therefrom by the person skilled in the art without departing from the scope of protection of the invention.

1-17. (canceled)

18. A circuit breaker device for protecting an electric low-voltage circuit, the circuit breaker device comprising:
a housing having grid-side connections and at least one load-side connection;
an electronic interruption unit having semiconductor-based switching elements, said electronic interruption unit being associated with said grid-side connections;
a mechanical isolating contact unit having contacts, said mechanical isolating contact unit having a series connection to said electronic interruption unit, and said mechanical isolating contact unit being associated with said at least one load-side connection;
said mechanical isolating contact unit configured to be switched by opening said contacts to prevent a current flow or by closing said contacts to allow a current flow in the low-voltage circuit;
said electronic interruption unit configured to be switched by said semiconductor-based switching elements into a high-resistance state of said semiconductor-based switching elements to prevent a current flow or into a low-resistance state of said semiconductor-based switching elements to allow a current flow in the low-voltage circuit;
a current sensor unit for determining a current level in the low-voltage circuit;
a control unit connected to said current sensor unit, to said mechanical isolating contact unit and to said electronic interruption unit, for initiating prevention of a current flow in the low-voltage circuit upon exceeding at least one of current limits or current-time limits; and
a measurement impedance provided between conductors of the low-voltage circuit for causing a measurement current to flow through said electronic interruption unit via said grid-side connections, upon said contacts of said mechanical isolating contact unit being open and said electronic interruption unit being switched to low-resistance.

19. The circuit breaker device according to claim 18, wherein said measurement impedance has one end connected to said series connection between said mechanical isolating contact unit and said electronic interruption unit.

20. The circuit breaker device according to claim 19, wherein said measurement impedance has another end connected to a conductor at said grid-side connections.

21. The circuit breaker device according to claim 18, wherein said measurement impedance is at least one of an electrical resistor or a capacitor.

22. The circuit breaker device according to claim 18, wherein said measurement impedance is a series circuit of an electrical resistor and capacitor.

23. The circuit breaker device according to claim 18, wherein said measurement impedance has a high resistance or impedance value between 100 kOhm and 1 MOhm.

24. The circuit breaker device according to claim 18, wherein said measurement impedance has a high resistance or impedance value greater than kOhm.

25. The circuit breaker device according to claim 18, wherein said measurement impedance has a high resistance or impedance value greater than 1 MOhm.

26. The circuit breaker device according to claim 18, wherein said electronic interruption unit is switched to a low-resistance state for a first period of time, causing a measurement current to flow through said measurement impedance with said contacts of said mechanical isolating contact unit open and said electronic interruption unit switched to a high-resistance state, for a functional test of the circuit breaker device or of said electronic interruption unit.

27. The circuit breaker device according to claim 18, wherein a voltage level across said electronic interruption unit can be determined for a conductor.

28. The circuit breaker device according to claim 27, wherein:
the voltage level across said electronic interruption unit, specified by said measurement impedance, is determined with said electronic interruption unit switched to a high-resistance state and with said contacts of said mechanical isolating contact unit open; and
upon undershooting a first voltage threshold value, a first fault condition is present preventing at least one of a low-resistance state of said electronic interruption unit or a closure of said contacts.

29. The circuit breaker device according to claim 27, wherein:
the voltage level across said electronic interruption unit is determined upon said electronic interruption unit being switched to the low-resistance state for a first time period; and
a second fault condition being is upon exceeding a second voltage threshold value, preventing at least one of further switching of said electronic interruption unit to the low-resistance state or closure of said contacts.

30. The circuit breaker device according to claim 28, wherein, in an event of a fault condition, closing of said contacts of said mechanical isolating contact unit is prevented and no enable signal is output to said mechanical isolating contact unit.

31. The circuit breaker device according to claim 18, wherein said electronic interruption unit has a grid-side connection point and a load-side connection point, and a first voltage sensor unit is connected to said control unit for determining a first voltage level between said grid-side connection point and said load-side connection point.

32. The circuit breaker device according to claim 31, wherein:
said grid-side connections include a grid-side neutral conductor terminal and a grid-side phase conductor terminal;
a second voltage sensor unit is connected to said control unit for determining a second voltage level between said grid-side neutral conductor terminal and said grid-side phase conductor terminal;
a third voltage sensor unit is connected to said control unit for determining a third voltage level between said grid-side neutral conductor terminal and said load-side connection point of said electronic interruption unit; and
a first voltage level between said grid-side connection point and said load-side connection point of said electronic interruption unit is determined by a difference between the second and third voltages.

33. The circuit breaker device according to claim 18, wherein said grid-side connections include a grid-side phase conductor terminal, said at least one load-side connection includes a load-side phase conductor terminal, and said current sensor unit is provided on a circuit side between said grid-side phase conductor terminal and said load-side phase conductor terminal.

34. The circuit breaker device according to claim 30, which further comprises a mechanical handle associated with said mechanical isolating contact unit, closing of said contacts by said mechanical handle only being possible after an enable or enable signal.

35. The circuit breaker device according to claim 18, wherein:
upon said contacts of said mechanical isolating contact unit being closed and said electronic interruption unit having a low resistance:
said electronic interruption unit becomes high resistance and said mechanical isolating contact unit remains closed, for a determined current exceeding a first current value or the first current value being exceeded for a first time limit,
said electronic interruption unit becomes high resistance and said mechanical isolating contact unit is opened, for a determined current exceeding a second current value or for a second time limit; and
said electronic interruption unit becomes high resistance and said mechanical isolating contact unit is opened, for a determined current exceeding a third current value.

36. The circuit breaker device according to claim 18, wherein said control unit has a microcontroller.
